(19) United States
(12) Patent Application Publication
(10) Pub. No.: US 2014/0238975 A1
(43) Pub. Date: Aug. 28, 2014

(54) MONOLITHIC THERMAL HEATING BLOCK MADE FROM REFRACTORY PHOSPHATE CEMENT

(71) Applicants: Sergey D. Alferyev, Seversk (RU); Valeriy Polyakov, Tomsk (RU)

(72) Inventors: Sergey D. Alferyev, Seversk (RU); Valeriy Polyakov, Tomsk (RU)

(21) Appl. No.: 14/351,571

(22) PCT Filed: Oct. 10, 2012
(86) PCT No.: PCT/RU2012/000842

§ 371 Date: Apr. 13, 2014

(30) Foreign Application Priority Data
Oct. 13, 2011 (RU) 2011141547

(51) Int. Cl. H05B 3/62

(52) U.S. Cl. CPC H05B 3/62
USPC 219/540

(57) ABSTRACT

The invention relates to the field of resistance heating in industrial resistance furnaces and, more specifically, to monolithic cement thermal heating blocks. The monolithic thermal heating block having a heating element disposed therein, the symmetry axes of which coincide with the symmetry axes of the monolithic thermal heating block, is made of nonelectrically but thermally conductive refractory phosphate cement. The heating element comprises a zigzag-shaped filament heater and strip terminals, wherein the area and circumference of the filament and the area and circumference of a terminal are in a ratio of not less than 1:4, and the sites where the filament heater is connected to the terminals are in the form of conical recesses in the monolithic thermal heating block. The technical result of the invention is the production of a monolithic nonelectrically conductive heating block that combines high efficiency, reliability, and manufacturability.

### FIELD OF THE INVENTION

The invention relates to the field of resistance heating in industrial resistance furnaces and, more specifically, to monolithic cement thermal heating blocks.

### BACKGROUND OF THE INVENTION

The design process and use of industrial resistance furnaces outlined the following main requirements for heating elements: high efficiency, reliability, durability, and nonconductivity.

According to M. A. Mikheev and I. M. Mikheeva, the most efficient heat transfer process from hot to cold compared to direct heating and other forms of heat transfer is the method of contact conductivity (Principles of Heat Transfer [in Russian], Moscow, Energiya Press, 1977, p. 17). In Calculation and design of electric resistance heaters, LA. Feldman described a maximum efficient shape for a heating resistance element made of a round zigzag-shaped wire (Moscow & Leningrad, Energiya Press, 1966, p. 18).

The closest heating element which was selected as a prototype is described in Patent No. Jia 2311742 of the Russian Federation of Jan. 2, 2003, IPC H05B 3/14. The said heating element is made of a ferrous material with a resistance element, located in the insulating layer, coated with the composite thermal and protective layers, in which heat is transferred from the resistance element to the surface through a composite insulating structure made of a few ceramic and organic matters. The insulating composite structure is designed for smoothing variations in the resistance element and the material of the heating element of a coefficient of thermal expansion (CTE). The resistance element is coated with an insulating layer from oxidation. The heating element is done by successive pressing in a few molds and the final firing.

The disadvantages of said heating element are as follows.
High electrical conductivity of the working surface of the element made of ferrous material (not less than 75%), which is prohibited by the electrical safety requirements for works performed in industrial resistance furnaces during the tempering, hardening, and heating processes of metal products of various configurations;
A phased technology for manufacturing heating elements in several molds and press tools greatly complicates the process and increases the cost of the manufacturing process.

### SUMMARY OF THE INVENTION

The object of the present invention is to design a monolithic nonconductive heating block, which combines high efficiency, reliability, and manufacturability. The technical result of the invention is to design a monolithic nonconductive heating block, which combines high efficiency, reliability, and manufacturability.

A monolithic thermal heating block is made of nonelectrically but thermally-conductive refractory phosphate concrete. It is filled with a heating element that comprises a zigzag-shaped filament heater and strip terminals. The area and circumference of the filament and the area and circumference of a terminal are in a ratio of not less than 1:4 and the sites where the filament heater is connected to the terminals are in the form of conical recesses in the monolithic thermal heating block.

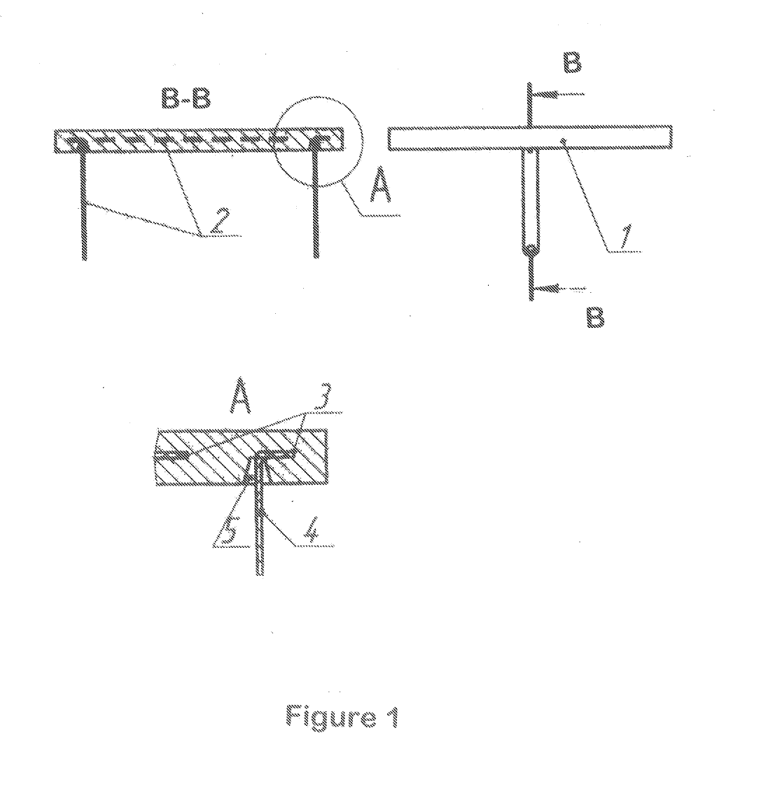

FIG. 1 shows a design of thermal heating unit.

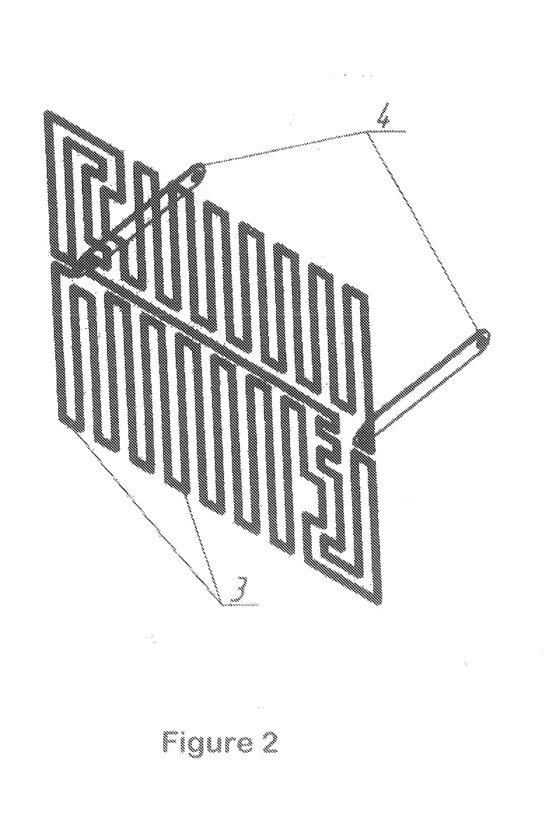

FIG. 2 shows a heating element.

A monolithic thermal heating block (FIG. 1) has the shape of a monolithic base (1). The linear sizes of the heating element (2), made of a zigzag-shaped filament heater (3) (FIG. 2), as the most effective type of heater, and the strip terminals (4) determine the linear sizes of the block.

The heating element (2) (FIG. 1) is located within the thermal heating block (1), wherein the symmetry axes of the heating element (2) coincide with the symmetry axes of the thermal heating block (1). Heat from the entire area of the heating element is transferred to the phosphate material via contact thermal conductivity, while concrete density provides for almost absence of oxidation of the metal heater. In the heating element (2) (FIG. 2), a sectional view, wire length, and a zigzag step of the filament heater (3) are set by a computed value of electrical resistance of the heating element (2), i.e. required efficiency of the thermal heating block. With this, the area and circumference of the filament and the area and circumference of a terminal are in a ratio of not less than 1:4. The terminal length is determined by the fixing method with the power cable and the lining thickness of a certain furnace.

The aforementioned conditions eliminate the operating defects of the furnace, such as burnout of the heating element in the sites where the heater connects with the terminal and high temperature on the terminal which leads to burnout of a clamping device of power supply cable with the terminals, namely:
Fold increase in the circumference of the terminal with respect to the circumference of the filament reduces the current density of the same fold on the terminal surface with a corresponding decrease in the electric resistance of the terminal and temperature decrease therein;
Fold increase in the terminal area with respect to the filament area leads to a fold reduction in the heat flux density in a terminal with a corresponding increase in thermal resistance of the terminal, heat dissipation, and temperature decrease;
The minimum required terminal length, which provides an additional increase in thermal resistance and a decrease in temperature along the terminal axis from the site where the heater connects with the terminal to the site where the terminal connects with the power supply cable, serves the same goal.

FIG. 1 shows a junction of the filament heater (3) with the terminal (4) shaped as a conical recess (5) in the thermal block for preventing the energy transfer from the material of the heating block to the terminals by contact heat conductivity.

The monolithic phosphate concrete block is homogeneous and has the same thermal conductivity along all three ordinates, which ensures, given that the symmetry axes of the heating element coincide with the symmetry axes of the heating block, uniform temperature distribution along the entire block and each plane of the block, including temperature equalization on the working surface of the block. The heating blocks are connected freely in the panel of any size for the resistance furnace of the required capacity.

Relative porosity of up to 20% of crystalline phosphate concrete, on the one hand, and high strength of up to 70 MPa, on the other hand, provide damping of thermal expansion of the metal heating element, which increases its plasticity with the temperature increase, without damaging the thermal block itself.

The strength and hardness of the thermal heating block made of phosphate concrete allow using it on the resistance furnace bottoms, which reduces power consumption up to 35%.

### INDUSTRIAL APPLICABILITY

The claimed invention is implemented on a bogie-type hearth resistance furnace with a working volume of 1.2 cubic meters and a working temperature of +1150° C. The furnace is heated by 28 monolithic thermal heating blocks, the size of 400×400×30 mm with electric resistance of 1.5 Ω each, gathered together in 5 panels that allows to reach 3 phase electrical power up to 30 kW.

1. (canceled)

2. A monolithic thermal heating block presenting a symmetry axis, said monolithic thermal block comprising;
a heating element disposed in said monolithic thermal heating block, said heating element presenting a symmetry axes coinciding with the symmetry axes of said monolithic thermal heating block, said heating element made of nonelectrically but thermally conductive refractory phosphate cement, and
a zigzag-shaped filament heater and strip terminals, wherein the area and circumference of said zigzag-shaped filament and the area and circumference of said terminals are in a ratio of not less than 1:4, and sites where said zigzag-shaped filament heater is connected to said terminals are in the form of conical recesses in said monolithic thermal heating block.

3. A monolithic thermal heating block presenting a symmetry axis, said monolithic thermal block comprising;
a heating element disposed in said monolithic thermal heating block, said heating element presenting a symmetry axes coinciding with the symmetry axes of said monolithic thermal heating block, said heating element made of no electrically but thermally conductive refractory phosphate cement, and
a zigzag-shaped filament heater and strip terminals.

4. The monolithic thermal heating block as set forth in claim 3, wherein the area and circumference of said zigzag-shaped filament and the area and circumference of said terminals are in a ratio of not less than 1:4.

5. The monolithic thermal heating block as set forth in claim 3, wherein sites where said zigzag-shaped filament heater is connected to said terminals are in the form of conical recesses in said monolithic thermal heating block.
